(19) United States
(12) Patent Application Publication
(10) Pub. No.: US 2003/0000813 A1
(43) Pub. Date: Jan. 2, 2003

(54) Device for matrix switching

(75) Inventor: Sture Roos, Bergshamra (SE)

Correspondence Address: NIXON & VANDERHYE P.C., 8th Floor, 1100 North Glebe Road, Arlington, VA, 22201, US

(73) Assignee: Telefonaktiebolaget LM Ericsson

(21) Appl. No.: 10/176,397

(22) Filed: Jun. 21, 2002

Related U.S. Application Data
(63) Continuation-in-part of application No. 09/982,251, filed on Oct. 16, 2001.
(60) Provisional application No. 60/245,735, filed on Nov. 3, 2000.

(30) Foreign Application Priority Data
Nov. 3, 2000 (EP) 00850187.6
Nov. 2, 2001 PCT/SE01/02410

(51) Int. Cl. H01H 9/00

(52) U.S. Cl. 200/1 R

(57) ABSTRACT

The present invention relates to a switching device for optional connection of a number of incoming electrical lines with a number of outgoing electrical lines, where the incoming and outgoing lines each are connected to individual contact surfaces (34, 36, 38) respectively, that the contact surfaces are arranged in concentric ring-shaped areas, a manoeuvring unit arranged in the centre of said ring-shaped areas, drive means (14) capable of rotating said manoeuvring unit, a number of contact elements (44) arranged to said manoeuvring unit, whereby the manoeuvring unit is capable of positioning said contact elements for obtaining electrical contact between specific, chosen, contact surfaces.

### TECHNICAL FIELD

The present invention relates to a switching device for optional connection of a number of incoming electrical lines with a number of outgoing electrical lines such as for handling of telephone lines in access networks.

### BACKGROUND ART

Several different designs of matrix crosspoint switching devices are known and have been used for different applications. Matrix crosspoint switching devices are generally designed with a plurality of incoming conductors and a plurality of outgoing conductors, where they form a matrix with a plurality of crosspoints.

In networks such as for example telephony it is desired to have automatic, remotely controlled crosspoint switches in order to connect cables in for example buildings and distribution cabinets. As regards telephone stations there is also a desire to have automatic switching between different types of service units and for connecting telephone subscribers.

A type of matrix crosspoint switching device utilising balls as contact elements at the crosspoints is disclosed in U.S. Pat. No. 4,954,674. The device comprises a connection block with a plurality of cavities containing crosspoints of the plurality of contact pairs, where each cavity comprises an electrically conductive ball and an electrically insulating ball. The balls are positioned such as to provide electrical contact or no electrical contact between incoming conductor pairs in one direction and outgoing conductor pairs in the outgoing direction with the aid of operating rods which transmit the operating force from one connection site to an adjacent operating site.

The device according to U.S. 4,954,674 significally reduces the size of a crosspoint matrix switching device in contrast to the conventional mechanical relaying devices. However it comprises a large number of elements that are movable with respect to contact surfaces and to each other, which complicates the manufacture of the device. It is further not an ideal solution as regards flexibility and size in in view of the increasing demands on reducing the size, i e packing density, and high flexibility. These demands call for matrix switching devices that can fully fulfil this. Further, inexpensive solutions are also called for.

### BRIEF DESCRIPTION OF THE INVENTION

The object of the present invention is to provide a switching device capable of optionally connecting a number of incoming electrical lines with a number of outgoing electrical lines in a way that is space saving, flexible and inexpensive.

This object is solved by a device characterised by claim 1. Preferable embodiments of the invention are characterised by the dependent claims.

The benefits of the present invention are several. By arranging electrical contact surfaces on a cylindrical surface, which contact surfaces are electrically connected to the incoming and outgoing electrical lines, and by providing an axially symmetrical rotatable body adjacent said cylindrical arranged with contact elements, it is possible to provide electrical contact between selected incoming lines and selected outgoing lines by rotating the symmetrical body. Because the whole circumference, i e 360°, of the cylindrical surface may be used it may be divided into a large number of contact points, thereby providing a large number of crosspoints between the incoming and outgoing lines. The contact surfaces may also be divided in the longitudinal direction of the cylindrical surface, facilitating the arrangement of the crosspoints in that the contact surfaces of the incoming lines are arranged over or under the contact surfaces of the outgoing lines as seen in the longitudinal direction, and designing the contact elements so that they are capable of bridging the gap between selected contact surfaces of the incoming lines with selected contact surfaces of the outgoing lines.

The design of the switching unit according to the invention provides a very compact solution. The symmetrical body is preferably driven by an electric motor, and more preferably by a stepper motor, which enables and facilitates the use of a plurality of contact points around the circumference of the cylindrical surface. The solution requires very little power consumption for the switching, and no power consumption when in the required contact position.

As an alternative design, the switching unit may be arranged such that the contact surfaces and contact points are arranged on a plane, for example a circuit board, in concentric rings or areas, that a drive means is arranged in the centre of the rings and that contact elements are arranged to the drive means and such that they provide a bridge between the contact surfaces and selected contact points.

The switching unit is further preferably provided with position signalling means, enabling a precise knowledge of the rotational position of the symmetrical body in relation to the cylindrical surface, and thus the crosspoints of the lines. The switching unit may further be provided with a home or reference position and memory means for storing the number of steps that the unit has moved.

The switching unit according to the invention may also be connected to further switching units, which greatly enhances the flexibility of the switching device. Preferably either the incoming or the outgoing lines are connected through all switching units and a set of outgoing or incoming lines respectively are arranged to a respective switching unit thereby providing a matrix crosspoint switching device, where each switching device is arranged with its own drive means for selectively connecting its set of lines with the through-going lines.

The sizes of the drive means available today enables a very compact design of the switching units, in the order of 20×20×10 mm for each unit. Preferably one unit or several interconnected units are connected to a printed circuit board comprising the necessary control means for activating the motors and to position the symmetrical body in order to obtain the required contacts between the incoming and outgoing lines. Further, if several switching units are interconnected, a connection block is arranged for directing the lines down to the circuit board, thereby reducing the wiring and facilitating the design and layout of the circuit board.

Further aspects of the present invention and advantages with it will become apparent from the following detailed description of the invention and from the accompanying drawings.

### DETAILED DESCRIPTION OF THE DRAWINGS

In the following detailed description of the invention, reference will be made to the accompanying drawings, of which

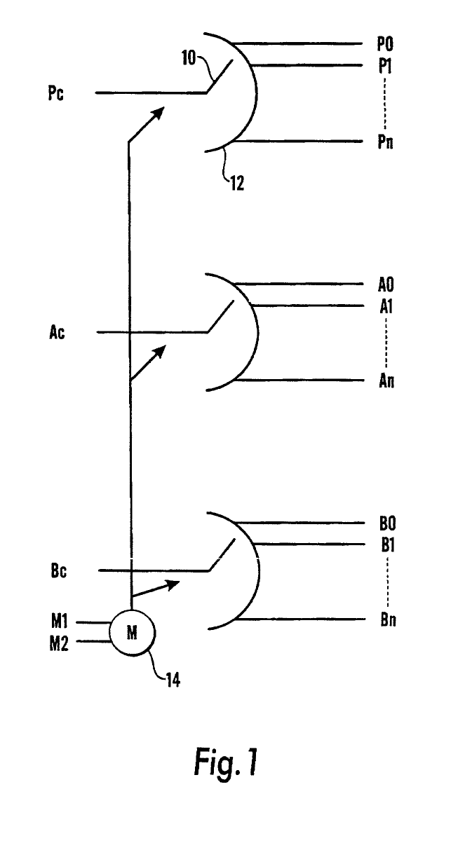

FIG. 1 shows symbolically the function of the present invention,

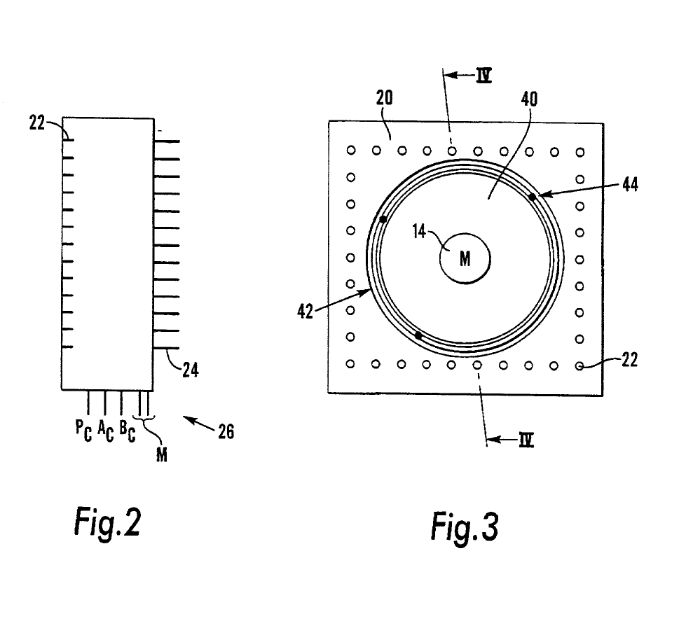

FIG. 2 shows a side view of a switching unit of the present invention,

FIG. 3 shows a front view of the switching unit of FIG. 2,

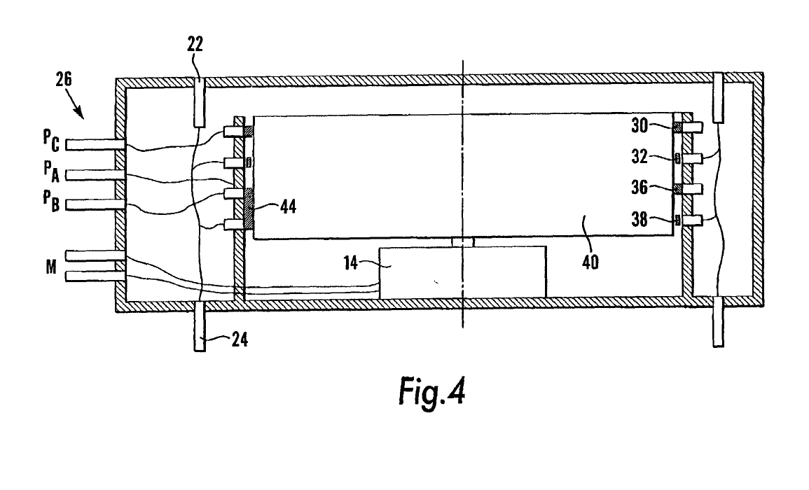

FIG. 4 shows a cross sectional view along line IV-IV of FIG. 3,

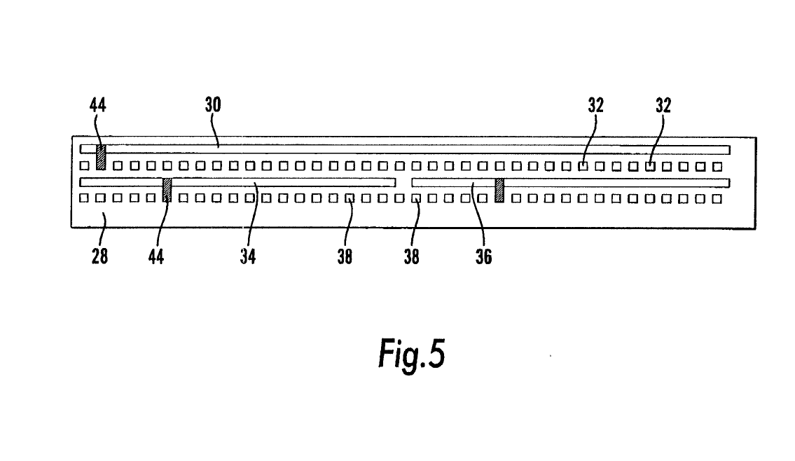

FIG. 5 shows an unfolded view of a cylindrical contact surface comprised in the switching unit of the invention,

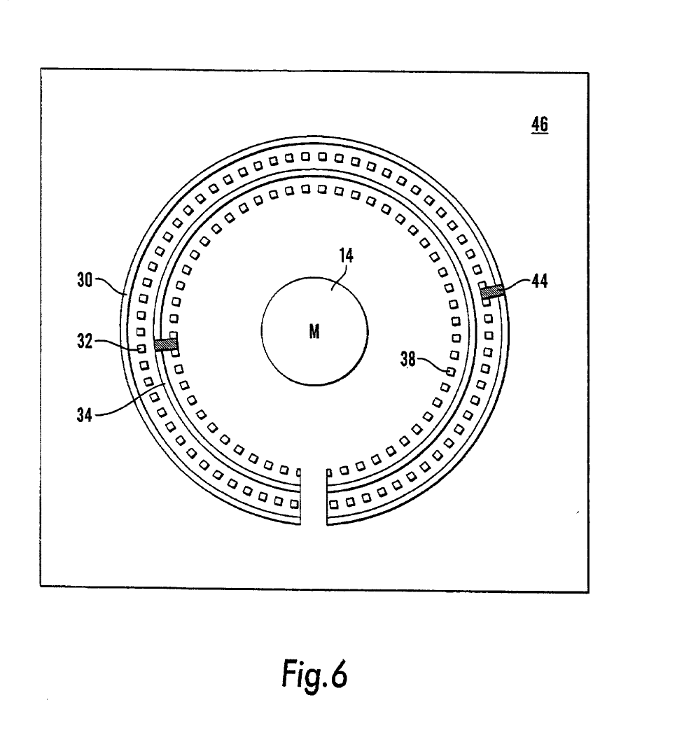

FIG. 6 shows another embodiment of the present invention,

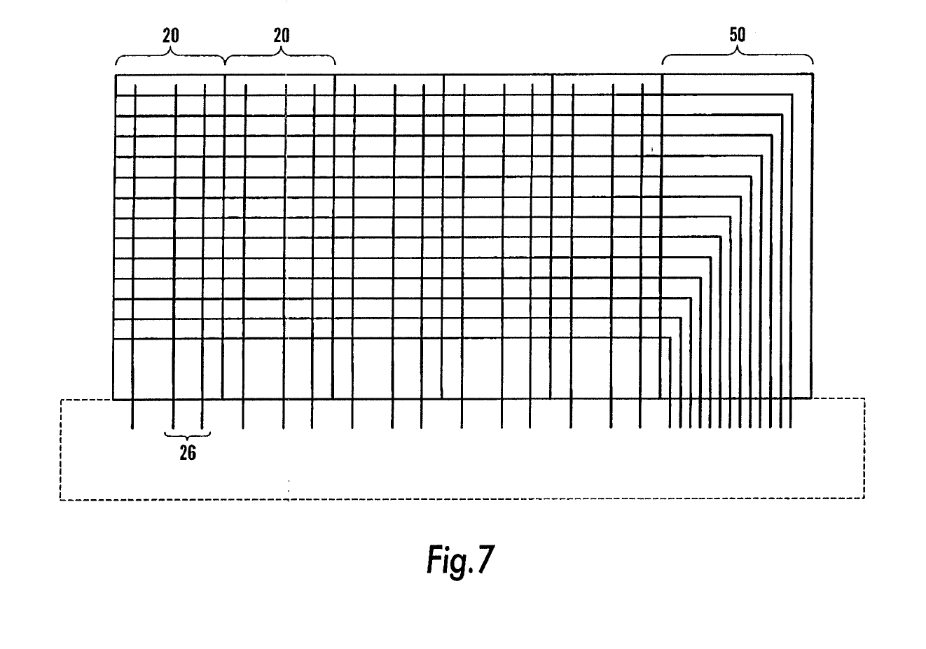

FIG. 7 shows how the switching units of FIG. 2 may be connected to each other,

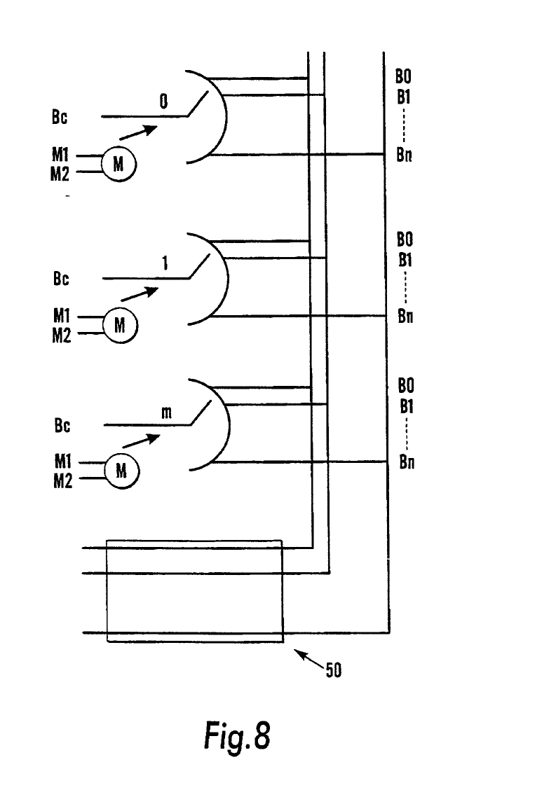

FIG. 8 shows symbolically the function of the present invention when switching units are connected to each other,

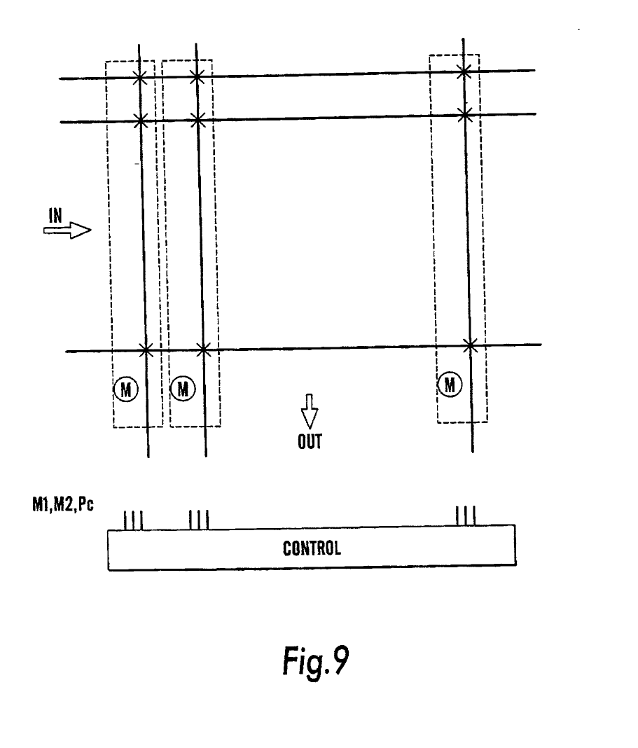

FIG. 9 shows a variant of the present invention, and

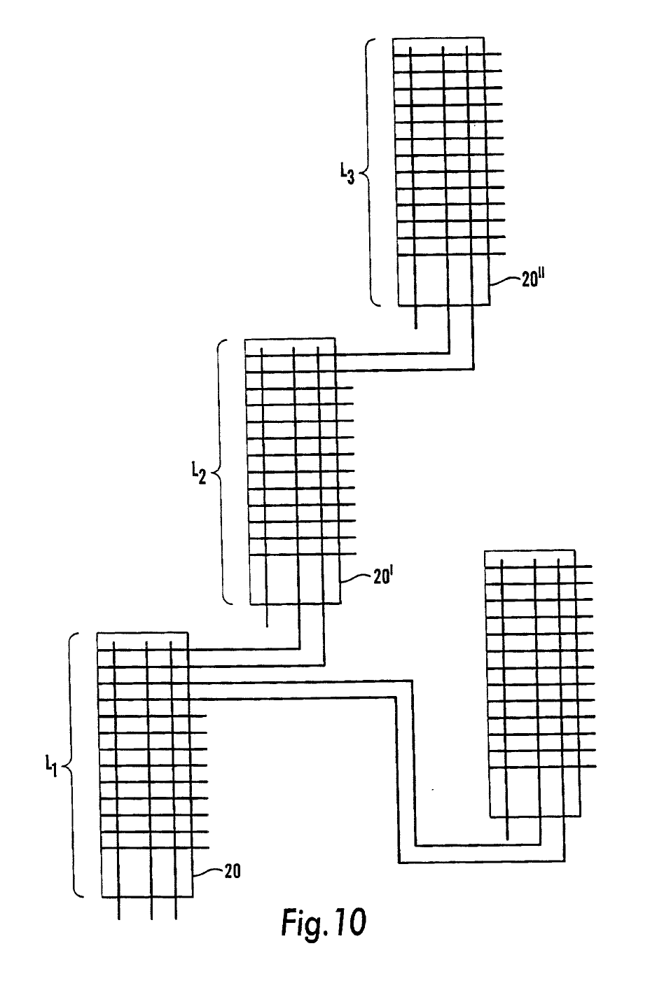

FIG. 10 shows switching units according to the invention connected in levels.

### DETAILED DESCRIPTION OF THE INVENTION

The present invention will now be described in connection with the accompanying drawings. In FIG. 1, showing the principle of the invention, two incoming lines Ac and Bc are shown, for example a pair of telephone lines, and a positioning signal line Pc. Each incoming line and the positioning signal line may be connected by rotating a positioner 10 to a number outgoing lines P0-Pn, A0-An, B0-Bn, where n is the maximum number of outgoing lines selected for the actual application. The contact points of the outgoing lines are positioned on a circular curve 12. The positioner is operated by an electric motor 14, preferably a stepper motor, although any motor capable of moving the positioner between the separate contact points may be employed. Each positioner is jointly driven by the motor, which means that all positioners are moved for example one increment when the motor is stepped one increment.

FIGS. 2 to 4 show an example of an embodiment of a switching unit utilising the principle of FIG. 1. It comprises a housing 20 of a generally rectangular shape. The left side surface of the housing, as seen in FIG. 2, is arranged with a plurality of contact holes 22 arranged in a certain pattern and the right side surface is arranged with the same number of contact pins 24 and the same configuration as the contact holes. Each contact hole in a specific position is electrically connected to a contact pin at the corresponding position FIG. 4, thereby providing a through-going connection for the outgoing lines, as will be explained in detail below. The lower surface of the housing is arranged with a number of contact pins 26, where two of them are for the incoming lines Ac, Bc, one is for the signal line Pc and least two are electrical contacts for the motor.

The centre of the switching unit is arranged with a circular cylindrical recess, the side surface 28 of which is arranged with electrical contact areas, FIG. 5. As seen in FIG. 5, which is an unfolded view of the side surface, it comprises a contact path 30, the uppermost part, which is electrically connected to the contact pin for the signal line Pc. This contact path stretches a full 360° around the cylindrical recess. Below that contact part, a plurality of contact points 32 are arranged in a row, with a certain space between each contact point. These contact points are each connected to one of the through-going connections 22, 24, FIG. 4. Below these are two contact paths 34, 36 arranged in a row after each other and with some land between them at two points, whereby each contact path stretches somewhat less than 180° around the circumference of the cylindrical recess. Each of these contact paths is respectively connected to one of the incoming lines Ac, Bc.

Below these contact paths are a plurality of contact points 38, corresponding to the number of contact points of the plurality of upper contact points, and with a corresponding position in a vertical direction as seen in FIG. 4. These contact points are each connected to a specific outgoing connection, where the contact point in the lower row is connected to the same connection as the contact point of the upper row positioned vertically above. The rest of the cylindrical surface has an insulating material.

In the cylindrical recess a manoeuvring unit 40 is rotatably arranged, FIG. 3 and 4. The manoeuvring unit is formed as an axially symmetrical body with somewhat lesser diameter than the cylindrical recess, thereby forming a gap 42 between them. The manoeuvring unit is rotatable by an electric motor 14, preferably a stepper motor. The side surface if the manoeuvring unit is arranged with a plurality of holding means, corresponding to the number of contact points of the side surface of the cylindrical recess and with the same pitch as the contact points. Contact elements 44 are provided for being releasably attached to the holding means at selected locations around the circumference of the symmetrical body. The holding means are arranged such and/or the contact elements have such a configuration that only one contact pin can provide contact between the uppermost contact path and one of the plurality of contact points at the upper row at a specific location, while the other contact elements are capable of providing contact between one of the lower contact paths and a specific contact point of the lowermost row of contact points. In the embodiment shown, there is one contact element between each incoming line (contact path 34, 36) and the requested outgoing line (contact points 38), which is common in connection of telephone lines. It shall however be understood that for some applications, there might be more than one contact element for each incoming line, thereby connecting it to more than one outgoing line.

The function of the switching unit is as follows. The unit is attached to a holder, for example a printed circuit board (not shown) whereby the contact pins 26 of the incoming signals are in electrical contact with the circuit board and in turn to for example the lines of a telephone cable. The outgoing contact pins 24 are electrically connected to a number of telephone lines. The circuit board is arranged with a control unit which is capable of activating the motor in order to rotate the manoeuvring unit one or more steps in order to position the contact elements in-the desired positions. The control unit further provides information from the position signalling line Pc, in order for the control unit to keep track on the actual position of the manoeuvring unit and its contact element in relation to the contact points of the cylindrical recess.

If the control unit receives a request for connecting the incoming pair of lines to certain outgoing pair of lines, the motor is activated and the manoeuvring unit is rotated a number of steps in a rotational direction from its actual position until the requested contact points 38 of the outgoing lines are reached and the new connection is obtained in that the contact elements 44 bridge the gap between the contact points and the respective contact path 34. The position signal enables a control of the actual position of the manoeuvring unit at any time, which thus eliminates any storage of data concerning the crosspoints connected.

The switching unit may further or instead be provided with a home or reference position and the control unit may be provided with memory means in order to keep track of the number of steps that the manoeuvring unit has moved from the reference position.

FIG. 6 shows another embodiment of the switching unit according to the invention. Instead of a cylindrical surface, the contact paths 30, 34 and contact points 32, 38 are arranged on the same plane, for instance the surface of a circuit board 46, in concentric rings and ring-shaped areas respectively. In the centre of the rings a stepper motor 14 is arranged with the same function as for the previous embodiment. To the stepper motor a manoeuvring unit is arranged (not shown) rotatable above the plane. The manoeuvring unit is arranged with holding means, corresponding to the number of contact points and with the same pitch as the contact points. Contact elements 44 in the form of collector shoes or the like are provided for being releasably attached to the holding means at selected locations on the manoeuvring unit. The holding means are arranged such and/or the contact elements have such a configuration that only one contact pin can provide contact between the outermost contact path 30 and one of the plurality of contact points at the adjacent ring area at a specific location, while the other contact elements are capable of providing contact between the inner contact paths and a specific contact point of the adjacent ring area of contact points. In order to obtain electrical contact between the different contact paths and contact points and external wiring or the like, a number of conductor bands may be arranged in the circuit board, in different layers if necessary, in a manner known to the man skilled in the art.

FIG. 7 shows how a number of switching units 20 connected to each other, where each switching unit is arranged in the same way as described above. The units are arranged to each other so that the contact pins 24 of one unit fit into the contact holes 22 of an adjacent unit, whereby the outgoing conductors are connected through all the units. Each unit is provided with a couple of incoming lines 26 and a position signal line as well as connections for the motor. This configuration enables the connection of a plurality of incoming lines with a plurality of outgoing lines. Each unit is provided with its own motor for connecting the incoming lines of that unit with the requested outgoing lines passing through the units. The last, or first, unit is preferably attached to a connection block 50. The function of the connection block is to direct all the conductors of the outgoing lines to the printed circuit board, shown with broken lines, thus eliminating the connection of the outgoing lines of each switching unit to the circuit board, which could lead to difficulties in the layout of the circuit board.

With the embodiment shown in FIG. 6 no connection block is needed since several switching units may be arranged on a large circuit board and where the different switching units are connected by connector bands arranged in or on the circuit board. Further, several circuit boards may be interconnected by ribbon cables and the like.

By connecting a suitable number of switching units, a large crosspoint matrix is obtained, FIG. 7, where only one branch is shown, and because the units are easily connectable to each other, it provides a very flexible solution.

It is naturally conceivable to change the position of the incoming and the outgoing lines on the switching unit, FIG. 8. One advantage with that configuration is that if switching unit fails, due for example to a break down of its motor, another outgoing line may be chosen whereby redundancy is obtained in the system.

FIG. 10 shows a schematic view of connecting the switching units according to the invention in levels, in order to manage a large number of outgoing lines. On the first level L1 one switching unit 20 is shown. It is connected to the incoming lines AC and BC. The outgoing connections of the switching unit are connected to the incoming connections of a further switching unit 20′ on the second level L2. In turn the outgoing connections of the second level switching unit is connected to a further switching unit 20″ on the second level L3. In this way the incoming lines may be connected to a very large number of outgoing lines, thereby increasing the connection points.

Apart for the first level, only one further switching unit is shown connected to the outgoing lines of a previous unit. Of course many further switching units may be connected to a previous switching unit, as shown at the first level, thereby even further increasing the possible switching connections. Further, the switching units may connected as shown in FIG. 7, thereby increasing the number of incoming lines to a level.

When a number of switching units are connected in the manner described in connection with FIG. 10, it is necessary to arrange so that the contact elements that are moved between the actual position and the new requested position are prevented from coming in contact with the contact points that are positioned between, which contact points may be connected. Such a contact may otherwise disturb the connection. The contact elements may therefore be arranged with means capable of lifting them during movement of the manoeuvring unit so that they cannot come in contact with contact points between the actual and the new position.

Another way of dealing with this is to have the control unit move the contact elements of each switching unit one at the time to a rest position between two contact points, where one of the contact points is the requested one, and when all switching units are positioned in that way, all switching units are activated and all manoeuvring units are moved simultaneously to the requested adjacent contact points.

Even though the embodiments described deal with line couples, which is the common arrangement for telephone lines, it is to be understood that the present invention is equally suitable for any number of lines.

It is to be understood that the above described and shown embodiments are only to be regarded as non-limiting examples of the present invention and that it may be modified within the scope of protection.

1. Switching device for optional connection of a number of incoming electrical lines with a number of outgoing electrical lines, where the incoming and outgoing lines each are connected to individual contact surfaces (34, 36, 38) respectively, that the contact surfaces are arranged in concentric ring-shaped areas, a manoeuvring unit arranged in the centre of said ring-shaped areas, drive means (14) capable of rotating said manoeuvring unit, a number of contact elements (44) arranged to said manoeuvring unit, whereby the manoeuvring unit is capable of positioning said contact elements for obtaining electrical contact between specific, chosen, contact surfaces.

2. Switching unit according to claim 1, wherein said contact surfaces are arranged on a cylindrical surface (28), that said manoeuvring unit comprises an axially symmetric body (40) arranged adjacent said cylindrical surface, and that a number of contact elements (44) are arranged to said body on the surface which is facing the cylindrical surface.

3. Switching device according to claim 2, wherein the contact surfaces of the incoming lines are arranged above or under the contact surfaces of the outgoing lines as seen in the direction of the centre line, and that the contact elements are arranged and designed such that they are capable of bridging the contact surfaces of the incoming and outgoing lines.

4. Switching device according to claim 1 or 2, wherein the contact surfaces of the incoming and/or the outgoing lines are arranged as contact points (38) arranged in rows along the circumference of the cylindrical surface.

5. Switching device according to any of the preceding claims, wherein the symmetrical body is arranged with a number of fastening means capable of releasably holding the contact elements in a number of positions around the circumference of the symmetrical body.

6. Switching unit according to claim 1, wherein said contact surfaces are arranged on a plane in concentric ring areas, that said manoeuvring unit is arranged in the centre of said ring areas.

7. Switching device according to claim 6, wherein the contact surfaces of the incoming lines are arranged outside or inside the contact surfaces of the outgoing lines as seen in the radial direction, and that the contact elements are arranged and designed such that they are capable of bridging the contact surfaces of the incoming and outgoing lines.

8. Switching device according to claim 6 or 7, wherein the contact surfaces of the incoming and/or the outgoing lines are arranged as contact points (38) arranged in rows along the ring areas of the plane surface.

9. Switching device according to any of the preceding claims, wherein the manoeuvring unit is arranged with a number of fastening means capable of releasably holding the contact elements in a number of positions.

10. Switching device according to any of the preceding claims, wherein it further comprises a position sensing device (30, 32) capable of sensing the rotational position of the axially symmetrical body in relation to the cylindrical surface.

11. Switching device according to any of the preceding claims, wherein the drive means comprises a stepper motor.

12. Switching device according to any of the preceding claims, wherein the device comprises means for connecting to a further connection device and means for electrically connecting the number of incoming or outgoing lines of one device with the number of incoming or outgoing lines of the further device.
